(19) United States
(12) Patent Application Publication
(10) Pub. No.: US 2008/0156208 A1
(43) Pub. Date: Jul. 3, 2008

(54) APPARATUS AND METHOD FOR PRINTING IN A WEB-FED PRINTING PRESS

(75) Inventors: Thomas GSELL, Dillingen (DE); Rudolf STROH, Duernau (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/957,344

(22) Filed: Dec. 14, 2007

(30) Foreign Application Priority Data
Dec. 16, 2006 (DE) 10 2006 059 561.0

(51) Int. Cl. B41F 7/02

(52) U.S. Cl. 101/217; 101/492

(57) ABSTRACT

An apparatus and method for printing in a web-fed printing press is disclosed. A printing unit has several printing couples, where each printing couple includes a transfer cylinder, an inking system, and a dampening system, if applicable. Each printing couple includes a plate cylinder unit featuring at least two plate cylinders, where, when a plate cylinder of the plate cylinder unit is engaged on the transfer cylinder of the respective printing couple during a printing operation, the, or each, other plate cylinder of the corresponding plate cylinder unit is disengaged from the transfer cylinder of the respective printing couple.

This application claims the priority of German Patent Document No. 10 2006 059 561.0, filed Dec. 16, 2006, the disclosure of which is expressly incorporated by reference herein.

### BACKGROUND AND SUMMARY OF THE INVENTION

The invention relates to an apparatus and method for printing in a web-fed printing press.

Printing units of web-fed printing presses known from practice have several printing couples, whereby each printing couple features a transfer cylinder, a plate cylinder, an inking system as well as a dampening system if applicable. The plate cylinders are also designated as engraving cylinders and the transfer cylinders as blanket cylinders. In addition, such printing units have impression cylinders, whereby an impression cylinder can cooperate with one or more transfer cylinders of different printing couples. The impression cylinders are also designated as satellite cylinders, which is why printing units with at least one impression cylinder are also designated as satellite printing units. In addition to the satellite printing units that have impression cylinders, printing units are also known that have no impression cylinders, whereby, in the case of printing units having no impression cylinders, the transfer cylinders of two printing couples roll off of one another.

Printing plates bearing the image to be printed are positioned on the plate cylinders of the printing couples of a printing unit. When the image being printed changes, the printing plates must be exchanged or reimaged and the printing operation on the printing press must be interrupted to do so. Consequently, during the execution of a printing plate change and/or the execution of printing plate imaging, a printing unit is not available for printing. This limits the production availability of a printing unit.

Starting herefrom here, the present invention is based on the objective of creating a novel apparatus and method for printing in a web-fed printing press.

According to the invention, each printing couple includes a plate cylinder unit featuring at least two plate cylinders, wherein, when a plate cylinder of a plate cylinder unit is engaged on the transfer cylinder of the respective printing couple during a printing operation, the, or each, other plate cylinder of the corresponding plate cylinder unit is disengaged from the transfer cylinder of the respective printing couple.

In terms of the present invention, each printing couple of the inventive printing unit includes a plate cylinder unit featuring at least two plate cylinders. A plate cylinder of the plate cylinder unit is engaged during a printing operation on the transfer cylinder of the respective printing couple. The, or each, other plate cylinder of the corresponding plate cylinder unit, on the other hand, is disengaged during the printing operation from the transfer cylinder of the respective printing couple. During the printing operation, printing plate changes or printing plate imaging can be performed on the plate cylinders that are disengaged from the transfer cylinders of the respective printing couple. As a result, the production availability of the inventive printing unit can be increased.

The plate cylinders of each plate cylinder unit are preferably positioned on respectively one joint support so that the plate cylinders of each plate cylinder unit can be jointly displaced with respect to the transfer cylinder of the respective printing couple.

Preferred developments of the invention are yielded from the following description. Without being limited hereto, exemplary embodiments of the invention are explained in greater detail on the basis of the drawing.

### BRIEF DESCRIPTION OF THE DRAWING

FIG. 1 is an inventive printing unit of a web-fed printing press.

### DETAILED DESCRIPTION OF THE DRAWING

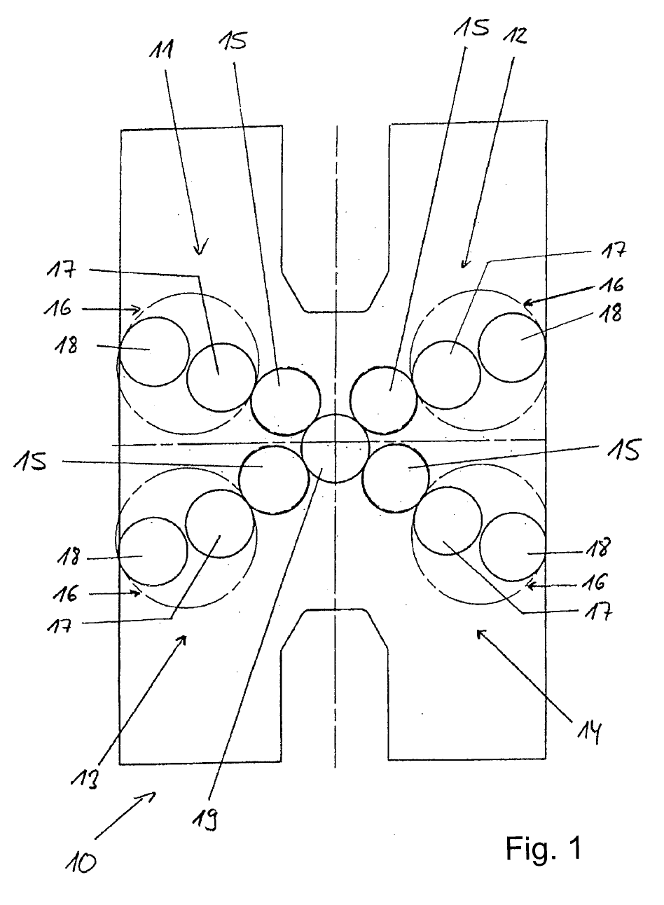

FIG. 1 shows a schematic representation of an inventive printing unit 10 of a web-fed printing press, whereby the printing unit 10 in FIG. 1 is embodied as a satellite printing unit.

Thus, the printing unit 10 in FIG. 1 has four printing couples 11, 12, 13, and 14, whereby each printing couple 11, 12, 13 and 14 has a transfer cylinder 15 and whereby all transfer cylinders 15 roll off on an impression cylinder 19, which is also designated as a satellite cylinder. In addition to the transfer cylinder 15, each printing couple 11, 12, 13 and 14 also has a plate cylinder unit 16, an inking system (not shown) as well as preferably a dampening unit (also not shown).

The plate cylinder unit 16 of each printing couple 11, 12, 13 and 14 has two plate cylinders 17 and 18 in the depicted exemplary embodiment. During a printing operation when one of the plate cylinders 17 is engaged on the transfer cylinder 15 of the respective printing couple 11, 12, 13, and/or 14, the other plate cylinder 18 of the corresponding plate cylinder unit 16 is disengaged from the transfer cylinder 15 of the respective printing couple 11, 12, 13, and/or 14.

The plate cylinder 17 of a plate cylinder unit 16 engaged during the printing operation on the transfer cylinder 15 of the respective printing couple 11, 12, 13 and/or 14 is coupled on the drive side to the respective printing couple 11, 12, 13 and/or 14. The plate cylinder 18 of a plate cylinder unit 16 disengaged during the printing operation from the transfer cylinder 15 of the respective printing couple is decoupled on the drive side from the respective printing couple.

The plate cylinders 17 and 18 of each plate cylinder unit 16 are preferably positioned on respectively one joint support. The plate cylinders 17 and 18 of a plate cylinder unit 16 are consequently jointly displaceable with respect to the transfer cylinder 15 of the respective printing couple 11, 12, 13 and/or 14, namely, on the one hand, for disengaging and engaging in a linearly adjustable manner as well as in a disengaged state with respect to the transfer cylinder 15 of the respective printing couple.

The plate cylinder 17 engaged on the transfer cylinder 15 of a printing couple 11, 12, 13 and/or 14 as well as coupled on the drive side to the respective printing couple is used during the printing operation to apply a printed image and/or partial printed image on a printing substrate.

A printing plate change or printing plate imaging can be performed on the plate cylinder 18 disengaged during the printing operation from the transfer cylinder 15 as well as decoupled on the drive side from the respective printing couple. When performing a printing plate change, a printing plate can be exchanged manually or automatically on the respective printing cylinder 18. When performing printing plate imaging on the respective plate cylinder 18, an imaging device is preferably engaged on the plate cylinder; this imaging device is used to delete an old print image from the printing plate positioned on the plate cylinder 18 and then a new print image may be applied.

In contrast to the depicted exemplary embodiment, it is also possible for each plate cylinder unit 16 to have more than two plate cylinders, whereby exclusively one of the plate cylinders is then engaged on the transfer cylinder 15 of the respective printing couple during the printing operation, and whereby the other plate cylinders of the printing unit 16 are disengaged during the printing operation from the respective transfer cylinder 15.

The printing unit 10 in accordance with the invention is operated as follows to perform a printing plate change and/or printing plate imaging on at least one printing couple of the printing unit: After completing a printing job, the inking system (not shown) as well as any applicable dampening system (also not shown) on at least one printing couple 11, 12, 13, and/or 14 are disengaged from the plate cylinder that was engaged to the transfer cylinder 15 during the previous printing operation. Then the plate cylinder unit 16 of the respective printing couple 11, 12, 13 and/or 14 is displaced in such a way that the plate cylinder that was engaged on the transfer cylinder 15 of the respective printing couple during the previous printing operation is disengaged from the transfer cylinder 15 and a plate cylinder that was disengaged from the transfer cylinder 15 of the respective printing couple during the previous printing operation is engaged on the transfer cylinder 15 of the respective printing couple. Following this, the inking system as well as the dampening system if applicable will be engaged on the plate cylinder that is engaged on the transfer cylinder 15 of the respective printing couple for the subsequent printing operation. At the same time as the printing operation that is to be performed subsequently, a printing plate change and/or printing plate imaging will be performed on the plate cylinder that is now disengaged from the transfer cylinder 15 of the respective printing couple. Because of the parallel nature of the printing operation with a printing plate change or printing plate imaging, the production availability of the printing unit 10 can be increased.

### LIST OF REFERENCE NUMERALS

10 Printing unit
11 Printing couple
12 Printing couple
13 Printing couple
14 Printing couple
15 Transfer cylinder
16 Plate cylinder unit
17 Plate cylinder
18 Plate cylinder
19 Impression cylinder

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit of a web-fed printing press having a printing couple, wherein the printing couple includes a transfer cylinder and a plate cylinder unit and wherein the plate cylinder unit includes a first plate cylinder and a second plate cylinder, wherein, when the first plate cylinder of the plate cylinder unit is engaged on the transfer cylinder during a printing operation, the second plate cylinder of the plate cylinder unit is disengaged from the transfer cylinder during the printing operation.

2. The printing unit according to claim 1, wherein the first and second plate cylinders of the plate cylinder unit are positioned on one joint support so that the plate cylinders are jointly displaceable with respect to the transfer cylinder.

3. The printing unit according to claim 1, wherein the first plate cylinder of the plate cylinder unit engaged during the printing operation on the transfer cylinder is coupled on a drive side to the printing couple.

4. The printing unit according to claim 1, wherein the second plate cylinder of the plate cylinder unit disengaged during the printing operation from the transfer cylinder is decoupled on a drive side from the printing couple.

5. The printing unit according to claim 1, wherein a printing plate change is performable on the second plate cylinder of the plate cylinder unit that is disengaged during the printing operation from the transfer cylinder.

6. The printing unit according to claim 1, wherein a printing plate imaging is performable on the second plate cylinder of the plate cylinder unit that is disengaged during the printing operation from the transfer cylinder.

7. A printing unit of a web-fed printing press, comprising:
a transfer cylinder; and
a plate cylinder unit, wherein the plate cylinder unit includes a first plate cylinder and a second plate cylinder, and wherein the first and second plate cylinders are alternately engageable with the transfer cylinder.

8. A method for printing in a web-fed printing press, comprising the steps of:
changing an image on a first plate cylinder of a plate cylinder unit during a printing operation by the plate cylinder unit; and
printing with a second plate cylinder of the plate cylinder unit during the printing operation by the plate cylinder unit.

9. The method according to claim 8, wherein when the image is changed on the first plate cylinder the first plate cylinder is not engaged with a transfer cylinder, and wherein when the second plate cylinder is printing the second plate cylinder is engaged with the transfer cylinder.

10. The method according to claim 8, further comprising the step of reconfiguring the plate cylinder unit for a second printing operation by the plate cylinder unit, wherein the step of reconfiguring the plate cylinder unit for the second printing operation by the plate cylinder unit includes the steps of:
engaging the first plate cylinder on a transfer cylinder; and
disengaging the second plate cylinder from the transfer cylinder.

11. The method according to claim 10, further comprising the steps of:
printing with the first plate cylinder during the second printing operation; and
changing an image on the second plate cylinder during the second printing operation.

12. The method according to claim 10, wherein the first plate cylinder is coupled to the second plate cylinder such that the engaging and disengaging steps occur simultaneously.

13. The method according to claim 10, wherein the step of disengaging the second plate cylinder from the transfer cylinder causes the step of engaging the first plate cylinder on the transfer cylinder.

14. The method according to claim 8, further comprising the steps of:
decoupling a drive of the first plate cylinder from a printing couple; and
coupling a drive of the second plate cylinder to the printing couple.

15. The method according to claim 8, wherein the step of changing the image on the first plate cylinder of the plate cylinder unit during the printing operation of the plate cylinder unit includes the step of changing a printing plate on the first plate cylinder.

16. The method according to claim 8, wherein the step of changing the image on the first plate cylinder of the plate cylinder unit during the printing operation includes the steps of deleting a first image on the first plate cylinder by an imaging device and applying a second image on the first plate cylinder by the imaging device.
